(19) United States
(12) Patent Application Publication
(10) Pub. No.: US 2003/0208362 A1
(43) Pub. Date: Nov. 6, 2003

(54) Integrated screening system and method for tenants and rental applicants

(75) Inventors: Richard F. Enthoven, Dallas, TX (US); Connie L. Couch, Dallas, TX (US); Nicholas H. Enthoven, Dallas, TX (US); Dan Sellari, Southlake, TX (US)

Correspondence Address: Michael E. Martin, GARDERE WYNNE SEWELL LLP, 1601 ELM STREET, SUITE 3000, DALLAS, TX, 75201, US

(73) Assignee: RESIDENT DATA, INC., RICHARDSON, TX

(21) Appl. No.: 10/138,447

(22) Filed: May 3, 2002

(51) Int. Cl. G06F 17/60

(52) U.S. Cl. 705/1

(57) ABSTRACT

A system and method for identifying potential undesirable applicants for rental of properties, particularly residential apartments, and for increasing the collection rate for monies owed by defaulting tenants. The system and method may be provided by an entity which may also be a debt collection service and who maintains a tenant default database as well as a debt receivable database and screening reports database. Users of the system and method, such as apartment complex managers and other landlords, may make entries of irresponsible or defaulting tenants and make queries of applicants for apartment rentals or rentals of other property so as to avoid undesirable tenants. Data entry and retrieval may be carried out via a communications network, such as the Internet.

### BACKGROUND OF THE INVENTION

The leasing of residential dwelling units, namely, apartments, as well as commercial properties, is a major economic activity. For example, approximately thirty-five to forty percent of U.S. households are apartment or house rentals. Moreover, the turnover in apartment leasing, in particular, is typically in excess of thirty percent annually, thus generating millions of new leases per year. Unfortunate occurrences which arise out of leasing are late payment or nonpayment of rent, default on the terms and conditions of a lease, or other undesirable behaviors on the part of tenants of apartments and single family residences. These occurrences cost millions of dollars in unpaid rents, property damage and other expenses incurred by landlords. Apartment owners must often turn to debt collection enterprises to collect late payments or nonpayments of rent by tenants who have moved out of an apartment or other rental space without, in many cases, leaving a forwarding address.

However, persons who are likely to default on payment of rent or otherwise violate the terms of a lease may move from one apartment complex to another and become an undesirable tenant for a succeeding landlord. Generally, it has been very cumbersome, heretofore, to properly determine a prospective tenant's prior behavior as a tenant before an apartment owner or manager executes a lease, the tenant moves in and then becomes troublesome in one way or another, including failure to pay rent. In certain jurisdictions, adverse tenant relationships can be particularly vexatious for apartment managers and owners due to local regulations governing the tenant/landlord relationship. Accordingly, there has been a substantially felt need for the development of a method and system for determining a person's desirability and history as a tenant for an apartment or other rental property. There has also been a substantially felt need for the development of an improved system which increases the yield of delinquent payments from tenants who have failed to pay rents to landlords where such tenants previously resided. In this respect improvement in unpaid rent collections may, of course, be realized if the current whereabouts of defaulting tenants can be determined. Hence, a system which may be accessed to record or determine a tenant's past history when applying for rental of a new residence may be advantageously linked to a debt collection system so that the debt collection system can be alerted and updated as to the defaulting tenant's whereabouts. Accordingly, it is to overcome the lack of ability to prescreen prospective tenants or rental applicants and to overcome the lack of ability to locate defaulting tenants that the present invention has been developed.

### SUMMARY OF THE INVENTION

The present invention provides an integrated screening system and method for identifying undesirable tenants or prospective tenants or renters of property, including, in particular, residential apartments and the like. The present invention also provides an improved system and method for locating defaulting tenants to improve debt collection yields.

In accordance with one important aspect of the invention, a system is provided which includes a tenant default database which may be accessed by landlords and property leasors, and is particularly adapted for the apartment leasing industry. Accordingly, a prospective tenant or apartment renter, for example, may be screened to determine whether or not such prospective tenant has a late payment history, has submitted prior fraudulent rental applications, has been subject to eviction filings or eviction notices, has “skipped” or has otherwise defaulted on prior leases or property rentals. The database may, advantageously, be maintained by an entity or service provider which may also maintain a debt receivables database and may also perform or contract with landlords or apartment complex managers for debt collection services. Moreover, when a landlord or property leasor accesses the system of the present invention with regard to a prospective tenant, if such tenant has been in default and is of record in a debt collections database linked to the system, the debt collection service is alerted as to the whereabouts of such tenant. In this regard, since most, if not all, landlords will reject a prospective tenant who still owes past due rent on a previous lease or rental, past due rents are more easily collected.

The system and method of the invention may be available to participants or subscribers to a service entity or service provider, such participants including apartment and other property owners or managers. Communication is preferably carried out via a communications network, such as the Internet. Communication is carried out via electronic computing or processing equipment and for which a landlord, rental property manager or other subscriber may access the system. The service entity or provider controlling the system maintains databases and operational software in such a way as to provide for the system to be accessible through a communications network, which may include the Internet.

The present invention also provides a system and method wherein a subscriber to the system, such as a landlord or rental property manager or administrator, may enter certain information regarding a so-called defaulted tenant, which information is placed on a tenant default database. The system provides for an administrator of the service provider which manages or controls the database and the operational software to add, edit and delete entries in one or more system databases. Still further, the service provider managing and controlling the database may also maintain information regarding the identity of all properties and persons having access to the system.

The present invention further contemplates that a user of the system and method may enter a new listing of a defaulted tenant, or modify information in the defaulted tenants data file. Still further, the entity controlling the system may have the ability to enable and disable the system with respect to a subscriber.

In a preferred embodiment of the system, the tenant default database is linked to a debt collections database which is maintained by the service provider as part of a debt collections function for defaulted tenants and apartment renters who have failed to pay rents due. In this regard, the property owners or managers using the system of the invention may have access to the tenant default database if such owners and managers also utilize the service provider for a debt collection function or a tenant screening function. If a property owner or manager places an entry in the tenant default database of the system the owner or manager is required to provide documentation to verify the default condition. The system is also operable via a debt collection function to monitor entries in the tenant default database to prevent an entry in the tenant default database regarding money owed for past due rent if such an entry is not also of record in a debt receivables or debt collection database.

The system and method of the invention provides for increased accountability of tenants and applicants for rental property, encourages timely rent payment to the current landlord and increases consequences for persons who pay late, commit lease defaults or otherwise become undesirable renters or tenants. The system and method provide rapid notice to all subscribers to the system of problem renters or tenants who are about to move out or “skip” without payment of rent due, help locate tenants who have skipped when they try to lease another apartment, or another property, and provide for increased debt collection.

Those skilled in the art will further appreciate the system and method of the invention upon reading the detailed description which follows in conjunction with the drawing.

### BRIEF DESCRIPTION OF THE OF THE DRAWING

FIG. 1 comprises a somewhat schematic diagram of the integrated screening system and method for tenants and rental applicants in accordance with the invention;

FIG. 2 is a table of defaulted tenant negative action characteristics; and

FIG. 3 is an exemplary display of information regarding a tenant or rental applicant having a negative action status.

### DETAILED DESCRIPTION OF PREFERRED EMBODIMENTS

The system and method of the present invention may be carried out using commercially available computing equipment and commercially available software or computer programs which may be generated by those of ordinary skill in the art. Accordingly, in the description which follows particular details or data and functions are described in general terms and which are believed to be sufficient to enable one skilled in the art to create the system in accordance with the invention for use on a private or generally publicly available communications network, such as the Internet.

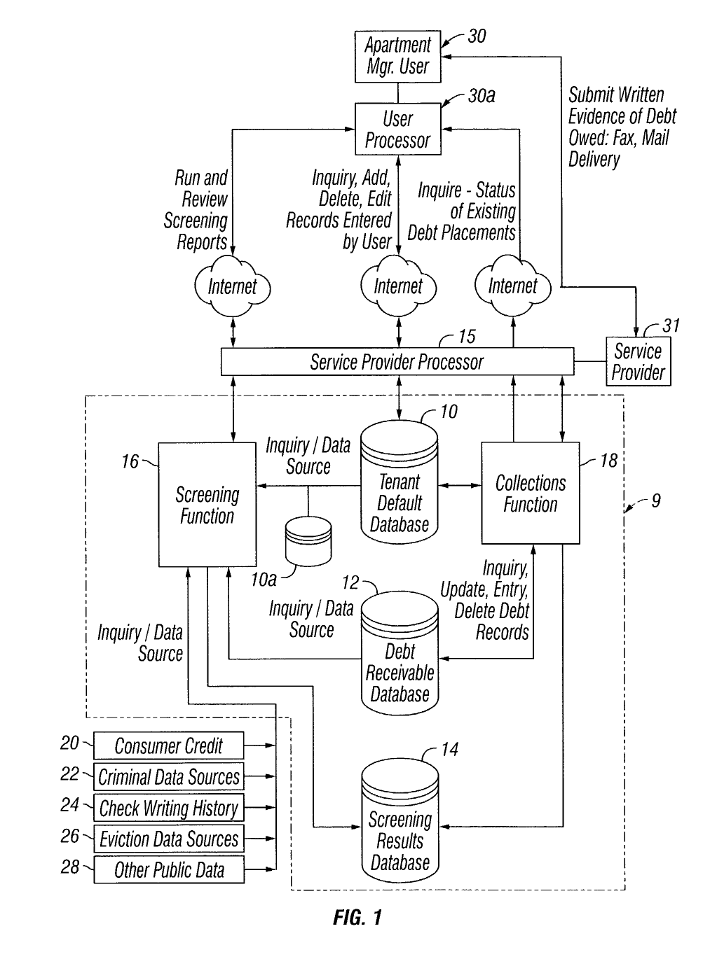

Referring to FIG. 1, there is illustrated a diagram of the system of the invention, generally designated by the numeral 9, and which includes three electronic databases, as indicated. A so-called tenant default database 10 is provided which includes detailed information to be described further herein concerning undesirable or potentially undesirable tenants or property renters and potential applicants for rental property. A debt receivable database 12 may be included as part of the system 9 and contains data regarding monies owed by individuals or entities for nonpayment of rent, including particulars of the defaulting party and the amounts of monies owed. Still further, the system 9 contemplates the inclusion of a database 14 for storage of selected data generated as a result of certain screening reports or screening functions which may be carried out in accordance with the invention.

Two major functions of the system and method of the invention are indicated in the diagram of FIG. 1 comprising a screening function 16 and a debt collection function 18 which utilize the database 10 as well as the databases 12 and 14 and may be carried out on a processor 15. The processor 15, typically, would be controlled and operated by an entity, such as a debt collection service business, hereinafter referred to as the service provider. The functions 16 and 18 can be used to develop reports regarding various defaulted tenant information or data as will be explained further herein. The system 9, via the screening function 16, may interact with additional databases, such as commercial consumer credit, criminal history, check writing history, apartment eviction sources and other public databases which may be accessed via the processor 15 and are indicated by numerals 20, 22, 24, 26 and 28, respectively. The screening function 16 and debt collection function 18 may be implemented by an administrator of the entity which controls and maintains the system 9 and method, including the databases 10, 12 and 14, for example. However, a major purpose of the system and method of the invention is to allow so-called subscribers to the system and method, namely, rental property owners or managers, to use the system 9 directly for screening applicants for rental of property, for inputting data regarding problem renters or tenants, including those that have defaulted on rental payments or leases, and providing for locating persons who owe rental payments from previous leases thereby increasing the rate of debt collection from defaulted tenants. In FIG. 1, numeral 30 indicates a typical subscriber to a service which includes the system and method of the present invention, which subscriber is designated as “Apartment Manager User”. The subscriber or user 30 preferably accesses the system 9 via the Internet, as indicated. Such communication may be carried out via one or more other electronic communications networks, if desired.

A user 30, for purposes of illustration, may be any subscriber to the system and method of the invention, such as an apartment complex owner or manager, or other administrators, managers or owners of various types of rental property. Although the system and method of the invention are primarily adapted for use by subscribers who are owners or managers of multiple dwelling unit properties, such as so-called apartment complexes, the system and method may be used in conjunction with other types of rental property. A user or subscriber 30 typically has access to the system 9 via a computer or processor 30a, which processor may be connected to the database 10 via the processor 15 for performing all of the functions of the system, which processor includes, at least in part, the elements 10, 12, 14, 16 and 18 and may be adapted to be connected to the databases 20, 22, 24, 26 and 28. A user 30, as well as an administrator of a service provider 31 who is operable to control the system and method of the invention, may make entries into the database 10 when a tenant or renter, through an overt act or an omission, performs a “negative action”. The user 30 thus reports this negative action with the goal of preventing the tenant from “skipping” (that is vacating the property while owing rent, or other lease obligations), punishing an already defaulted tenant, motivating a tenant to pay their debts and warning other users or subscribers to the system 9 about a defaulting tenant.

In the normal course of use of the system 9, the user 30 may determine that an entry should be made into database 10 for a tenant by accessing the Internet website, for example, of service provider 31 who has primary control over the system 9 and method, as indicated. Typically, the user 30 will require to provide a user name and password to gain access to the system 9 via the processor 15 which is controlled by the service provider or entity 31. The user 30 will then be prompted to indicate whether or not they wish to provide a new entry into the system 9. The following information would typically be entered into the tenant default database 10: (a) the first name, middle initial and last name of each person whose name appears on a lease which is the subject of the entry, and (b) the social security number of each person named on the lease. If a person does not have a social security number then other identifiers may be used, such as the first three letters of the person's first and last names and their date of birth. Additional information entered in database 10 includes (c) the apartment number and name of the property at which the default occurred, (d) the tenant move out date, (e) the date of lease violation, and (f) the amount of money owing on the lease. The last mentioned item may be an optional entry.

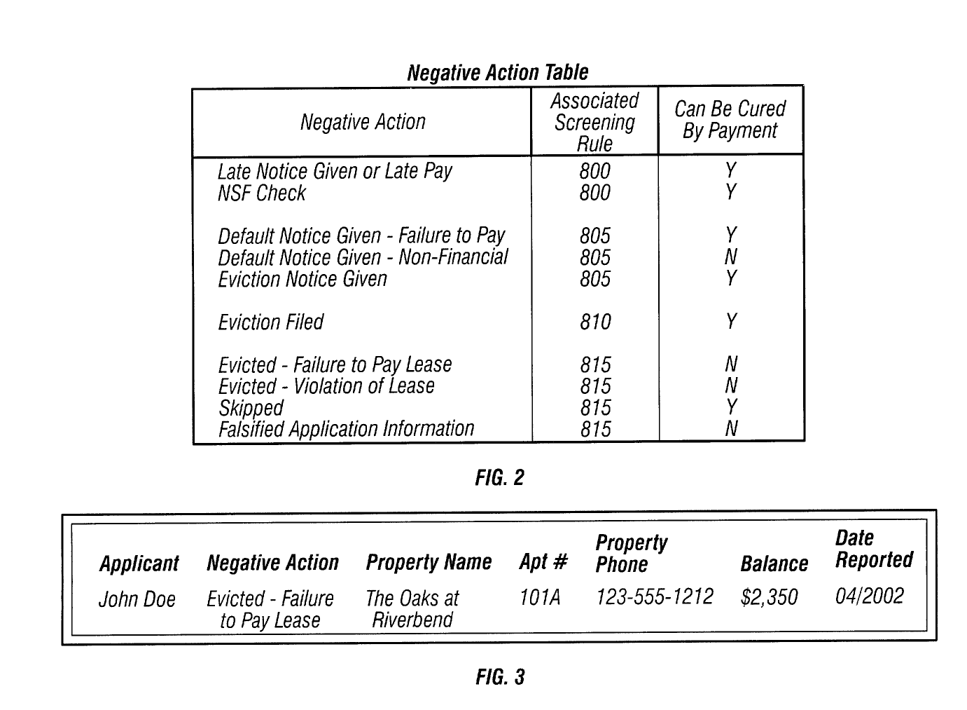

Certain identified and so-called Negative Actions may be entered in database 10 and associated with the defaulting or defaulted tenant entry. Negative Actions, see FIG. 2, may include Late Notice Given or Late Pay, making a rent payment with a non-sufficient funds (NSF Check), Default Notice Given (Failure to Pay or Non Financial), Eviction Notice Given, Eviction Filed, Evicted—Failure to Pay Lease, Evicted—Violation of Lease, Skipped (left the property without fulfilling lease obligation) or Falsified Lease Application Information. Certain ones of these Negative Actions may be given values related to certain screening criteria, and expiration of such Negative Action may be indicated on the database 10, such as whether or not the Negative Action expires with collection of money owed. The table of FIG. 2 gives a typical set of information of the type described above. The aforementioned process also provides for the user 30 to indicate that they are finished entering information in the system 9.

Alternatively, an administrator of the entity 31 may also enter the above described information using a user name and password and may carry out the same set of steps and data entry as described above for the user 30. Preferably, an entry is created for each person who is listed on a property lease and each entry is also identified with (g) its creation date, (h) the name of the property (apartment complex, for example) and (i) the name of the user. Access to the system 9 is provided only to users who have a registered name and password and if the system is not enabled for a particular property, the user will not have the ability to enter the above-described data. Moreover, if a required data item is missing when the entry is indicated to be completed, the entry will not be added. Typically, residential dwelling rentals (apartments) have four or fewer people named on the lease agreement. Accordingly, the system 9 is preferably adapted to allow for four names per entry or file and, if additional names are listed on a lease agreement, the process may be repeated by making a separate entry.

Users identified above may also modify an entry if incorrect information was entered or if the entry requires updating with additional information. A user 30, for example, would access the system 9 for modifying an entry in the same manner as for creating an entry, except a display screen or monitor on the processor being manipulated by the user will show or indicate that the user should make a keystroke indicating that they wish to see an existing entry. A list of entries entered in the past ninety days, for example, will then be displayed, typically, showing the tenant's name, date of entry, last date of residence, any Negative Action and amount of money owing, for example. If the desired entry is more than ninety days old, the user can indicate a wish to extend the search timeframe. The user 30 upon gaining access to a previous entry may then modify, for example, a tenant's social security number or date of birth, date of lease default, move out date and amount owing, for example. The user may optionally delete any one or more of the tenants listed in an entry. The user 30, for example, may also then indicate that they are finished with modifying an entry and that their changes should be saved.

Again, alternatively, an administrator of the service provider 31 may modify an entry generally as described above. Exceptions to making or modifying entries in the database 10 preferably include those wherein the user cannot delete every tenant name on an entry and the user must instead execute a separate user delete entry process. Moreover, if the system 9 is not enabled for a particular user, the user will not have the ability to modify an entry and a user cannot leave any required fields or bits of information for an entry blank. However, the system 9 is preferably configured such that, if the user attempts to do so the entry will not be entered or modified.

Of course, in accordance with the features of the system 9 of the invention, a user, either a property manager or administrator, such as the user 30, or an administrator of the service provider 31, may delete an entry from the system, including the database 10. The process of accessing the system 9 is as described above, the user indicates a desire to see the listing for a particular specific property, the user locates the desired entry, indicates they wish to delete it and the system asks the user to confirm the delete order, upon receipt of which the entry is deleted. However, if an entry still resides on the debt receivable database 12 with respect to a particular defaulted tenant, as a consequence of such defaulted tenant not having settled a debt obligation, then an entry in the database 10 for such defaulted tenant may not be deleted until a corresponding entry in database 12 has been deleted. In this way, if the service provider 31 is also providing debt collection services, then an entry for a particular defaulted tenant in database 12 will not be deleted or modified by the service provider until past debt collection or other obligation is settled.

When a new property (apartment complex, for example) is to be added to the system 9, a database 10a, FIG. 1, including a master list of all properties with users who have access, may require updating by an administrator of the service provider 31. The same process, essentially, will be carried out for deleting or disabling the system 9 with respect to a particular property or apartment complex, for example. The database 10a and the aforementioned disabling process are normally accessible only to the service provider or entity 31. Typically, for historical reasons, the service provider 31 will not completely delete data from the system 9 but disable access thereto by the user in question. The system 9 is also adapted to add a user, such as an administrator of a property participating in the system and method. This step may also be carried out by an administrator of the entity 31. Deletion of an administrator or user name is carried out in generally the same manner.

The data retrievable from the database 10 may be correlated with data in a debt receivable database 12 which is created as part of the debt collection function of the entity 31. Accordingly, any defaulted tenant entry retrieved from the database 10 as part of a screening function, or as part of a debt collection function, may also retrieve for that same tenant, a history of monies owed for previous lease violations, for example. The matching criteria between the databases 10, 12 and 14 may be the defaulted tenant individual's social security number or, if no social security number is available, other matching procedures may be implemented.

The Negative Action Table of FIG. 2 indicates the various Negative Actions previously mentioned, each of which is related to a so-called associated screening rule. Each Negative Action is also associated with an indicator as to whether or not the Negative Action has been “cured” by payment of a financial obligation due by the defaulted tenant. Certain Negative Actions can be cured by payment of obligations due, as indicated by “Y”, while other Negative Actions, such as Evicted—Failure to Pay Lease, are so grave as to be classified as that which cannot be cured by payment of any past due amounts, as indicated by “N”. The numbers indicated under the column headed “Associated Screening Rule” are related to particular screening tests or rules which apply for each of the Negative Actions. These screening rules may be modified in accordance with controlling governmental regulations, for example. The numbers identified in the middle column of the table of FIG. 2 indicated for the various screening rules are arbitrary and, as indicated previously, these screening rules are designed to comply with accepted industry practice and/or governmental regulations pertaining to privacy, for example. Accordingly, where a Negative Action has been cured by payment (Y) an inquiry of the system 9 by the user 30, for example, will not present a display of the type shown in FIG. 3 for review by the user. However, FIG. 3 indicates the type of information which will be provided to the user 30 after making an inquiry of the system 9, if a Negative Action associated with a defaulted tenant has not or cannot be cured.

For example, FIG. 3 illustrates a display of information resulting from a query submitted by a user of the system 9 for applicant “John Doe” and shows a Negative Action which has not been cured by payment. As indicated in FIG. 3, the type of Negative Action is displayed, together with the name of the property at which the tenant was evicted, apartment number, phone number of the property, the amount of money owing and the date reported by the property owner. Such information is displayed for the user so that the user may contemplate whether or not to proceed with renting property to the prospective tenant. Of course, a display such as that of FIG. 3 will also be provided to the user upon making a query concerning “John Doe” if the obligation which generated the Negative Action has not been cured. In other words certain Negative Actions, if cured by payment, will result in a person's name being deleted from database 10 while certain other Negative Actions will result in a substantially permanent record in database 10 which may be accessed by a user or subscriber to the system 9 for consideration as to whether or not the user wishes to rent a property to a particular prospective tenant.

The system 9 may also be capable of generating special reports including reporting of any record in the database 10 where no corresponding debt entry has been entered in the database 12. This exception report may be generated if the user 30 has not placed an entry in database 12 after “N” days of having submitted an entry in database 10, for example.

The system 9 may also generate a so-called exception report of any file or entry placed on database 12 and not placed on database 10 by a user 30 or an administrator of the entity 31. Still further, the system 9 may be configured to remove an entry in database 10 once a collection or debt payment has been settled by the debtor party of record in database 12. Still further, the system 9 may be configured to generate reports on any defaulted tenant who owes a debt and who is the subject of a screening report in the previous N days.

Those skilled in the art will appreciate that the system and method of the invention are advantageous in identifying potential problem applicants for apartment and other property rentals, and prevent irresponsible rental applicants from entering into lease agreements and moving into rental properties from which eviction may be difficult. The system 9 and method of the invention also assist in locating tenants of former properties who have “skipped” on payment of a lease obligation or other monies owed to a former landlord and encourage payment of previously incurred debts. In these respects, the system 9 and method carried out thereby assist entities which have responsibility for debt collection on “skipped” tenants.

Although preferred embodiments of a system and method in accordance with the invention have been described in detail hereinabove, those skilled in the art will recognize that various substitutions and modifications may be made without departing from the scope and spirit of the appended claims.

What is claimed is:

1. A method for determining an undesirable applicant for rental of property comprising the steps of:
providing a system including a tenant default database and at least a screening function for determining the identity of a potential undesirable tenant, said default database including the identity of an undesirable tenant based on criteria selected from a group consisting of a person's name, social security number, date of birth, date of previous lease violation, identity of property violated, monies owing from said previous violation and a reason for entry in said default database;
providing access to said default database by selected plural users; and
querying said default database by at least one of said users to determine if a record exists for an applicant for rental on said default database based on said criteria.

2. The method set forth in claim 1 including the step of:
acting on an application for lease of property based on the results of said query.

3. The method set forth in claim 1 including the step of:
providing access to said system for entry of defaulted tenant information including at least one of said criteria in said default database by selected ones of said users.

4. The method set forth in claim 1 including the steps of:
performing a screening function on said system based on tenant applicant information including at least selected parameters of said criteria and including a query to at least one additional database accessible by said system selected from a group consisting of a debt receivable database, a consumer credit database, a criminal data sources database, a financial check writing history database and an apartment eviction data source database.

5. The method set forth in claim 1 including the step of:
requiring user identity information before permitting user access to said default database.

6. The method set forth in claim 1 wherein:
at least one of a query of said default database and placing an entry of information in said default database is carried out by way of communication over an electronic communication network.

7. The method set forth in claim 6 including the step of:
providing a table of negative action reasons one or more of which may be associated with an entry in said default database.

8. The method set forth in claim 7 including the step of:
placing an identifier on at least a selected one of said negative action reasons which may cause deletion of said entry from said default database if said selected one of said negative action reasons is cured.

9. The method set forth in claim 8 including the step of:
generating a report from said default database including identifying a negative action associated with said entry if said negative action has not been cured.

10. The method set forth in claim 8 including the step of:
causing a negative action report to be deleted pursuant to collection of money owed by said applicant.

11. The method set forth in claim 1 including the steps of:
providing a debt receivable database of said system and linked to said default database; and
providing information indicating an amount of money owed by said applicant from a previous debt.

12. The method set forth in claim 11 including the step of:
generating a report of applicants of record in said default database for which no entry in said debt receivable database has been submitted by one or more of said users after N days.

13. The method set forth in claim 11 including the step of:
generating a report of potential applicants who have an entry of information in said debt receivable database without an entry of information in said default database.

14. The method set forth in claim 11 including the step of:
removing information from said default database pursuant to debt payment by said applicant.

15. The method set forth in claim 11 including the step of:
generating a report with respect to an applicant who owes a debt of record in said debt receivable database and who is the subject of a screening report requested by a user in the previous N days.

16. A system for recording and providing information related to an undesirable tenant for rental of property, said system being accessible by a computer processor and an electronic communications network, said system comprising a tenant default database and means for providing at least a screening function for determining the identity of an undesirable tenant, said default database including the identity of an undesirable tenant based on criteria selected from a group consisting of a person's name, social security number, date of birth, date of previous lease violation, identity of property violated, monies owing from said previous violation and a reason for entry in said default database.

17. The system set forth in claim 16 including:
a property identifier database accessible to an administrator of said system for adding and deleting the identity of a property accessible by a user of said system.

18. The system set forth in claim 16 including:
means for accessing a database selected from a group consisting of a consumer credit database, a criminal data source database, a check writing history database, an eviction data source database and public information database.

19. The system set forth in claim 16 including:
a debt receivable database accessible by a selected user of said system.

20. The system set forth in claim 19 wherein:
said debt receivable database and said default database are linked in such a way that information regarding an undesirable tenant may not be deleted from said default database if information regarding said undesirable tenant resides on said debt receivable database.

21. The system set forth in claim 19 including:
a screening results database for storing information resulting from an inquiry by a user of said system to at least one of said default database and said debt receivable database.

22. The system set forth in claim 16 including:
a negative action table including a list of negative actions one or more of which may be associated with information regarding an undesirable tenant residing in said default database.
